(19) United States
(12) Patent Application Publication
(10) Pub. No.: US 2010/0038289 A1
(43) Pub. Date: Feb. 18, 2010

(54) METAL SULPHONATE ADDITIVES FOR FOULING MITIGATION IN PETROLEUM REFINERY PROCESSES

(75) Inventors: Frank C. WANG, Annandale, NJ (US); Chris A. WRIGHT, Bordentown, NJ (US); Glen B. BRONS, Phillipsburg, NJ (US); Steven W. LEVINE, Flemington, NJ (US); L. Oscar FARNG, Lawrenceville, NJ (US)

Correspondence Address: ExxonMobil Research & Engineering Company, P.O. Box 900, 1545 Route 22 East, Annandale, NJ, 08801-0900, US

(73) Assignee: EXXONMOBIL RESEARCH AND ENGINEERING COMPANY, Annandale, NJ (US)

(21) Appl. No.: 12/533,425

(22) Filed: Jul. 31, 2009

Related U.S. Application Data
(60) Provisional application No. 61/136,173, filed on Aug. 15, 2008.

(51) Int. Cl. C10G 75/04; C09K 3/00; B01J 19/00

(52) U.S. Cl. 208/48 AA; 196/46; 252/182.3; 422/129; 422/198

(57) ABSTRACT

The present application provides a method for reducing fouling, including particulate-induced fouling, in a hydrocarbon refining process including the steps of providing a crude hydrocarbon for a refining process; adding an additive selected from:

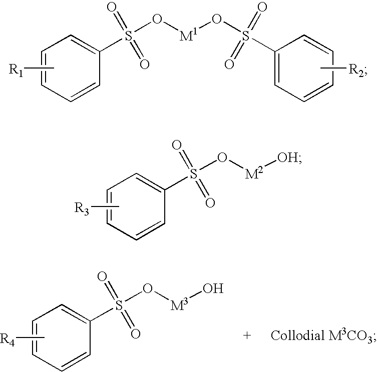

wherein R₁, R₂, R₃, and R₄ are independently selected from a branched or straight-chained C₅-C₈₀ alkyl group, and M¹, M², and M³ are independently selected from Ca, Mg and Na.

### CROSS REFERENCE TO RELATED APPLICATION

The application relates and claims priority to U.S. Provisional Patent Application No. 61/136,173 filed on Aug. 15, 2008.

### FIELD OF THE INVENTION

The present invention relates to additives to reduce fouling of crude hydrocarbon refinery components, and methods and systems using the same.

### BACKGROUND OF THE INVENTION

Petroleum refineries incur additional energy costs, perhaps billions per year, due to fouling and the resulting attendant inefficiencies caused by the fouling. More particularly, thermal processing of crude oils, blends and fractions in heat transfer equipment, such as heat exchangers, is hampered by the deposition of insoluble asphaltenes and other contaminants (i.e., particulates, salts, etc.) that are inherent in most crude oils. Further, the asphaltenes and other organics are known to thermally degrade to coke when exposed to high heater tube surface temperatures.

Fouling in heat exchangers receiving petroleum-type process streams can result from a number of mechanisms including chemical reactions, corrosion, deposit of existing insoluble impurities in the stream, and deposit of materials rendered insoluble by the temperature difference (ΔT) between the process stream and the heat exchanger wall. For example, naturally-occurring asphaltenes may precipitate from the crude oil process stream, thermally degrade to form a coke and adhere to the hot surfaces. Further, the high ΔT inherent in a heat transfer operation result in high surface or skin temperatures when the process stream is introduced to the heater tube surfaces, which contributes to the precipitation of insoluble particulates. Another common cause of fouling is attributable to the presence of salts, particulates and impurities (e.g. inorganic contaminants) found in the crude oil stream. For example, iron oxide/sulfide, calcium carbonate, silica, sodium chloride and calcium chloride have all been found to attach directly to the surface of a fouled heater rod and throughout the coke deposit. These solids may promote and/or enable additional fouling of crude oils.

The buildup of insoluble deposits in heat transfer equipment creates an unwanted insulating effect and reduces the heat transfer efficiency. Fouling also reduces the cross-sectional area of process equipment, which decreases flow rates and desired pressure differentials to provide less than optimal operation. To overcome these disadvantages, heat transfer equipment are ordinarily taken offline and cleaned mechanically or chemically, resulting in lost production time.

Accordingly, there is a need to reduce precipitation/adherence of particulates and asphaltenes from the heated surface to prevent fouling, and before the asphaltenes are thermally degraded or coked. This will improve the performance of the heat transfer equipment, decrease or eliminate scheduled outages for fouling mitigation efforts, and reduce energy costs associated with the processing activity.

### SUMMARY OF THE INVENTION

One aspect of the present application provides a method for reducing asphaltene and other particulate fouling in a hydrocarbon refining process. The method includes providing a crude hydrocarbon for a refining process, and adding to the crude hydrocarbon one or more additives selected from:

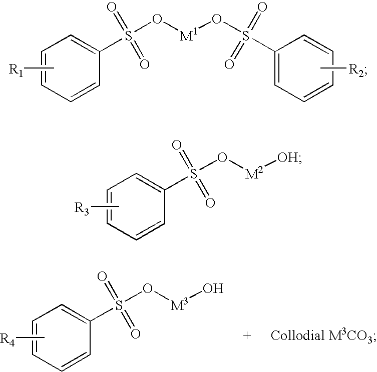

wherein R₁, R₂, R₃, and R₄ are independently selected from a branched or straight-chained C₅-C₈₀ alkyl group, and M¹, M², and M³ are independently selected from Ca, Mg and Na. In one particular embodiment, the above described methods are added to a crude hydrocarbon process stream to reduce particulate-induced fouling.

Another aspect of the present application is directed to a system for refining hydrocarbons. The system includes at least one crude hydrocarbon refinery component and crude hydrocarbon in fluid communication with the at least one crude hydrocarbon refinery component, wherein the crude hydrocarbon includes at least one of the above-mentioned additives. In one particular embodiment, the system is particularly adept at reducing and/or preventing particulate-induced fouling.

Another aspect of the present invention provides a composition for reducing fouling (e.g. particulate-induced fouling) that includes at least one of the above-described additives, optionally further including, a solubilizer for the additive, and, optionally further including, a performance enhancer for the additive (e.g. a dispersant such as a boronating agent).

### BRIEF DESCRIPTION OF THE DRAWINGS

The application will now be described in conjunction with the accompanying drawings in which:

FIG. 1 is a schematic representation of an oil refinery crude pre-heat train, annotated to show non-limiting injection points for the additives of the present application.

FIG. 2 is a schematic representation of the Alcor Hot Liquid Process Simulator (HPLS) employed in Example 2 of this application.

FIG. 3 is a graph demonstrating the effects of fouling of a crude oil stream and a crude oil stream treated with 250 wppm of a calcium sulfonate additive, as measured in the Alcor HPLS apparatus depicted in FIG. 2.

FIG. 4 is a graph demonstrating the effects of fouling of crude oil streams that contain 200 wppm of iron oxide particulates—with and without a calcium sulfonate additive.

### DETAILED DESCRIPTION OF THE INVENTION

### Definitions

The following definitions are provided for purpose of illustration and not limitation.

As used herein, the term “fouling” generally refers to the accumulation of unwanted materials on the surfaces of processing equipment or the like.

As used herein, the term “particulate-induced fouling” generally refers to fouling caused primarily by the presence of variable amounts of organic or inorganic particulates. Organic particulates (such as precipitated asphaltenes and coke particles) include, but are not limited to, insoluble matter precipitated out of solution upon changes in process conditions (e.g. temperature, pressure, or concentration changes) or a change in the composition of the feed stream (e.g. changes due to the occurrence of a chemical reaction). Inorganic particulates include, but are not limited to, silica, iron oxide, iron sulfide, alkaline earth metal oxides, sodium chloride, calcium chloride and other inorganic salts. One major source of these particulates results from incomplete solids removal during desalting and/or other particulate removing processes. Solids promote the fouling of crude oils and blends due to physical effects by modifying the surface area of the heat transfer equipment, allowing for longer holdup times at wall temperatures and causing coke formation from asphaltenes and/or crude oil(s).

As used herein, the term “alkyl” refers to monovalent hydrocarbon group containing no double or triple bonds and arranged in a branched or straight chain.

As used herein, a “boronating agent” include compounds encompassed by the formula:

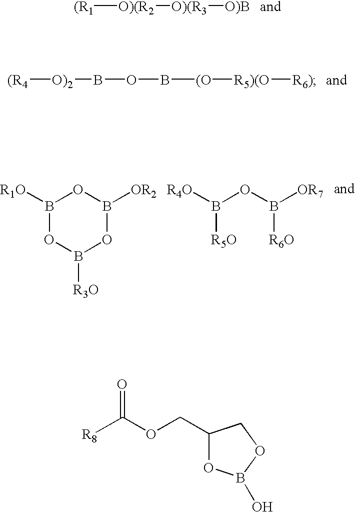

wherein R₁, R₂, R₃, R₄, R₅, R₆, R₇ and R₈ are independently C₃ to C₂₀ hydrocarbyl groups. Examples of these materials include Mobilad C-700 and Mobilad C-701.

As used herein, a “boronating agent” also includes compounds disclosed in International Published Application No. 1996/13618, applied for by Mobil Oil Corporation and hereby incorporated by reference in its entirety. Accordingly, boric acid can be used as a boronating agent; organic borates, particularly ortho-borates, meta-borates, trialkyl borates may also be used in additive-containing compositions of the present application. Suitable metaborates include but are not limited to trimethyl metaborate(trimethoxyboroxine), triethyl metaborate, tributyl metaborate. Suitable trialkyl borates include, without limitation, trimethyl borate, triethylborate, triisopropyl borate(triisopropoxyborane), tributyl borate(tributoxyborane) and tri-t-butyl borate. It is contemplated that boronating agents can be used in conjunction with the additives of this application.

As used herein, a “hydrocarbyl” group refers to any univalent radical that is derived from a hydrocarbon, including univalent alkyl, aryl and cycloalkyl groups.

As used herein, the term “crude hydrocarbon refinery component” generally refers to an apparatus or instrumentality of a process to refine crude hydrocarbons, such as an oil refinery process, which is, or may be, susceptible to fouling. Crude hydrocarbon refinery components include, but are not limited to, heat transfer components such as a heat exchanger, a furnace, a crude preheater, a coker preheater, or any other heaters, a FCC slurry bottom, a debutanizer exchanger/tower, other feed/effluent exchangers and furnace air preheaters in refinery facilities, flare compressor components in refinery facilities and steam cracker/reformer tubes in petrochemical facilities. Crude hydrocarbon refinery components can also include other instrumentalities in which heat transfer may take place, such as a fractionation or distillation column, a scrubber, a reactor, a liquid-jacketed tank, a pipestill, a coker and a visbreaker. It is understood that “crude hydrocarbon refinery components,” as used herein, encompasses tubes, piping, baffles and other process transport mechanisms that are internal to, at least partially constitute, and/or are in direct fluid communication with, any one of the above-mentioned crude hydrocarbon refinery components.

As used herein, a reduction (or “reducing”) particulate-induced fouling is generally achieved when the ability of particulates to adhere to heated equipment surfaces is reduced, thereby mitigating their impact on the promotion of the fouling of crude oil(s), blends, and other refinery process streams.

Reference will now be made to various aspects of the present application in view of the definitions above.

In accordance with one aspect of the present application, a method is provided for reducing fouling in which one or more additives are selected from:

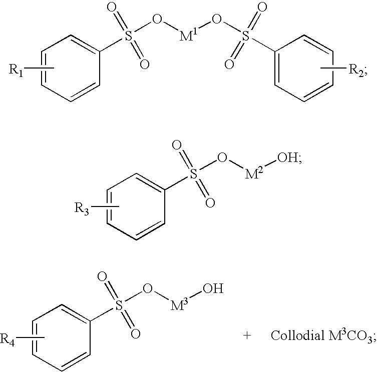

wherein R₁, R₂, R₃, and R₄ are independently selected from a branched or straight-chained C₅-C₈₀ alkyl group, and M¹, M², and M³ are independently selected from Ca, Mg and Na. The additive can be added to a crude hydrocarbon process stream in a variety of locations and manners as described in order to reduce various types of fouling. For example, the fouling can be particulate-induced fouling.

In one aspect of the present application, the selected additive is represented by the formula:

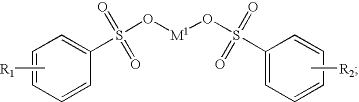

wherein R₁, and R₂ are independently selected from a branched or straight-chained C₅-C₈₀ alkyl group, and M₁ is selected from Ca, Mg and Na. In another embodiment, M¹ is Mg. In another embodiment, M¹ is Na. In another embodiment, R₁ and R₂ are independently a straight-chained C₅-C₈₀ alkyl group. In another embodiment, R₁ and R₂ are independently a straight-chained or branched C₅-C₃₀ alkyl group. In a still further embodiment, R₁ and R₂ are independently selected from a straight-chained or branched branched C₆-C₁₅ alkyl group.

In another aspect of the present application, the selected additive is represented by the formula:

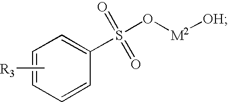

wherein R₃ is a branched or straight-chained C₅-C₈₀ alkyl group; and M² is selected from Ca, Mg and Na. In one embodiment, M² is Ca. In another embodiment, M² is Mg. In another embodiment, M² is Na. In another embodiment, R₃ is a straight-chained C₅-C₈₀ alkyl group. In another embodiment, R₃ is a straight-chained or branched C₅-C₃₀ alkyl group. In a still further embodiment, R₃ is a straight-chained or branched C₆-C₁₅ alkyl group.

In another aspect of the present application, the selected additive is represented by the formula:

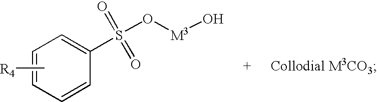

wherein R₄ is a branched or straight-chained C₅-C₈₀ alkyl group; and M³ is selected from Ca, Mg and Na. In one embodiment, M³ is Ca. In another embodiment, M³ is Mg. In another embodiment, M³ is Na. In another embodiment, M³ is Na. In another embodiment, R₄ is a straight-chained C₅-C₈₀ alkyl group. In another embodiment, R₄ is a straight-chained or branched C₅-C₃₀ alkyl group. In a still further embodiment, R₄ is a straight-chained or branched C₆-C₁₅ alkyl group.

Each of the selected additives described above can be added alone, or in combination with one or more other additives or other compounds as described.

Another aspect of the present invention provides a system for refining hydrocarbons that include at least one crude hydrocarbon refinery component, in which the crude hydrocarbon refinery component includes an additive selected from any one of the above-described additives. The crude hydrocarbon refining component may be selected from a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, and a visbreaker. In one preferred embodiment, the crude hydrocarbon refining component is a heat exchanger (e.g. a crude pre-heat train heat exchanger).

Another aspect of the present invention provides a composition for reducing fouling that includes at least one of any of the above-described additives, and optionally, a solubilizer for the additive; and optionally, a performance enhancer, such as a dispersant for the additive. In one embodiment, the composition for reducing fouling, includes a boronating agent as a dispersant. In one embodiment the boronating agent is selected from boric acids, and organic borates. Other embodiments of the present application do not include a dispersant, or do not include a boronating agent.

Exemplary further embodiments of the present application are provided below for illustrative purposes, and not for purposes of limitation.

### Applications for the Metal-Sulphonate Additives

The additives of the present application are generally soluble in a typical hydrocarbon refinery stream and can thus be added directly to the process stream, alone or in combination with other additives that contribute to either reduce fouling or improve some other process parameter in order to optimize the refining process.

The additives can be introduced, for example, upstream from the particular crude hydrocarbon refinery component(s) (e.g. a heat exchanger) in which it is desired to prevent fouling (e.g. particulate induced fouling). Alternatively, the additive can be added to the crude oil prior to being introduced to the refining process, or at the very beginning of the refining process.

While not limited thereto, the additives of the present application are particularly suitable in reducing or preventing particulate-induced fouling. Thus one aspect of the present application provides a method of reducing and/or preventing, in particular, particulate-induced fouling including adding at least one additive of the present application to a process stream that is known, or believed to contribute to particulate-induced fouling. To facilitate determination of proper injection points, measurements can be taken to ascertain the particulate level in the process stream.

In one embodiment of the present application, a method to reduce fouling is provided comprising adding any one of the above-mentioned additives to a crude hydrocarbon refinery component that is in fluid communication with a process stream that contains, at least 50 wppm of particulates, including organic and inorganic particulates. In another embodiment of the present application, a method to reduce fouling is provided comprising adding any one of the above-mentioned additives to a crude hydrocarbon refinery component that is in fluid communication with a process stream that contains, at least 250 wppm (or 1000 wppm, or 10,000 wppm) of particulates, including organic and inorganic particulates, as defined above.

In one embodiment of the present application, the additives of the present application are added to selected crude oil process streams known to contain, or possibly contain, problematic amounts of organic or inorganic particulate matter (e.g. 1-10,000 wppm), such as inorganic salts. Accordingly, the additives of the present application can be introduced relatively far upstream in the refining process, where the petrochemical process stream is relatively unrefined (e.g. the refinery crude pre-heat train). The additives can be also added, for example, after the desalter to counteract the effects of incomplete salt removal or to the bottoms exit stream from the fractionation column to counteract the high temperatures that are conducive to fouling.

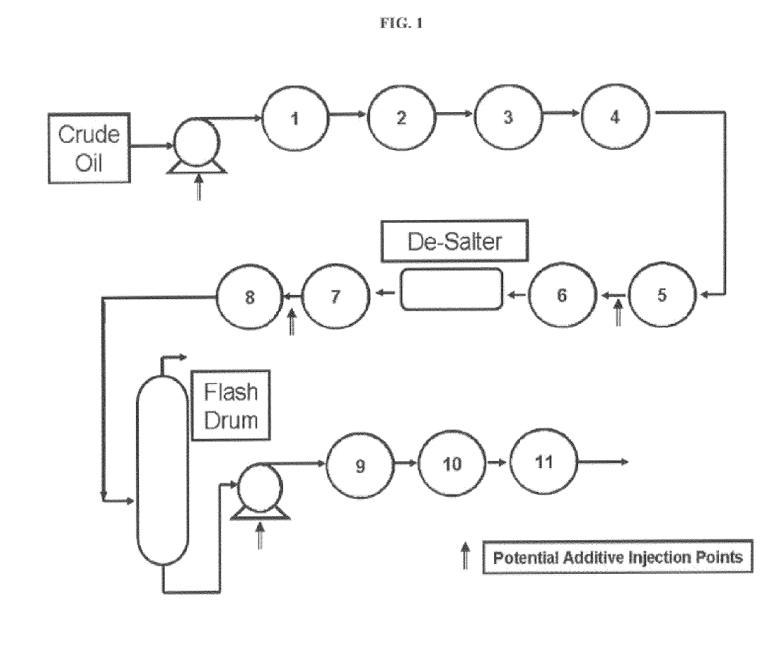

FIG. 1 demonstrates possible additive injection points within the refinery crude pre-heat train for the additives of the present application, wherein each numbered circle represents a heat exchanger. As shown in the Figure, the additives may be introduced in crude storage tanks and at several locations in the preheat train. This includes at the crude charge pump (at the very beginning of the crude pre-heat train), and/or before and after the desalter, and/or to the bottoms stream from a flash drum.

The additives of the present application may be added in a solid (e.g. powder or granules) or liquid form directly to the process stream. As mentioned above, the additives may be added alone, or combined with other components to form a composition for reducing fouling (e.g. particulate-induced fouling). Any suitable technique can be used for adding the additive to the process stream, as known by a person of ordinary skill in the art in view of the process to which it is employed. As a non-limiting example, the additives may be introduced via injection that allows for sufficient mixing of the additive and the process stream.

### Obtaining the Additives of the Present Application

The additives of the present application may be obtained from commercial sources, and are often described by their manufacturer as additives for motor oils and/or as lubricating oils.

For example, calcium sulfonates can be obtained from Infineum Corporation (Oxfordshire, UK and Linden, N.J.). One preferred additive of the present application is available as Infineum C9350, and is described as a long chain alkyl benzene sulfonate. According to the Existing Chemical Secondary Notification Assessment (NA/486S) entry for Infineum™ C9350 by Department of Health and Aging of the Australian Government, Infineum™ C9350 is a non-flammable, non-explosive, viscous brown liquid with a faint petroleum odor and low water solubility. Infineum™ C9350 is listed for use as a detergent additive in crankcase motor oils and as an additive to oils to be used as a lubricant in the cutting of metals.

Over-based and neutral calcium sulfonates may also be obtained from Chemtura Corporation (Middlebury, Conn.) under the trade names Hybase™ (e.g. Hybase™ C-231) and Lobase™ (e.g. Lobase™ C-4506).

Alternatively, the additives of the present application can be synthesized by persons of ordinary skill in the art. Exemplary synthesis techniques are disclosed, for example, beginning on page 805 of the Handbook of Hydraulic Fluid Technology (1989), edited by George E. Totten, ISBN: 9780824760229; “Synthesis and Rigorous Purification of Sodium Alkylbenzene Sulfonates,” Journal of American Oil Chemists' Society, Vol. 63, No. 10 (October 1986); “Synthesis and Characterization of Mono-Isomeric Alkylbenzene Sulfonates,” pp. 973-984 Petroleum Science and Technology, Vol. 24, No. 8 (Aug. 8 2006); U.S. Pat. Nos. 4,474,710; 3,105,810 and 3,328,283. Each of the above references are hereby incorporated by reference in their entirety.

### Compositions for Reducing Fouling

The additives of the present application generally are used in compositions, and in amount to reduce or prevent fouling, including particulate-induced fouling. In addition to the additives of the present application, the compositions optionally can further contain a hydrophobic oil solubilizer for the additive and/or a dispersant for the additive. Suitable solubilizers include, for example, surfactants, carboxylic acid solubilizers, such as the nitrogen-containing phosphorous-free carboxylic solubilizers disclosed in U.S. Pat. No. 4,368,133, hereby incorporated by reference in its entirety.

Also as disclosed in U.S. Pat. No. 4,368,133, hereby incorporated by reference, suitable surfactants can be included in compositions of the present application, such as any one of a cationic, anionic, nonionic or amphoteric type of surfactant. See, for example, McCutcheon's “Detergents and Emulsifiers”, 1978, North American Edition, published by McCutcheon's Division, MC Publishing Corporation, Glen Rock, N.J., U.S.A., including pages 17-33, which is hereby incorporated by reference in its entirety.

Suitable dispersants include, for example, a boronating agent, such as the boronating agents disclosed in U.S. Ser. No. 61/136,172 filed on Aug. 15, 2008, hereby incorporated by reference. For example, the compositions of the present application may include boric acid and organic derivatives of boric acid, such as ortho-borates, meta-borates and trialkyl borates. While not being bound by any particular theory, it is believed that the metal cation moiety and borate moiety form synergistically combine to increase the effectiveness of the resulting product.

In embodiments that employ a boronating agent dispersant, non-limiting metal (e.g. calcium, sodium, magnesium) to boron weight ratios range from about 1:20 to about 20:1, or from about 1:5 to about 5:1, or from about 1:2 to about 2:1.

Other polar elements or groups can be used to replace boron; however, there must be a minimum amount of metal present in the neat additive (e.g. a miminum amount of 0.4 wt % metal in the neat additive).

In one embodiment, the preferred total wt % polar elements is greater than or equal to 1.2 wt % of the neat additive. The total wt % polar elements, as used above, is based on the equation: total wt % polar elements=X (wt % metal)+Y (wt % boron)+Z (wt % oxygen)+W (wt % all other elements except carbon, hydrogen, oxygen and boron).

Other dispersants may be employed in compositions of the present application, including, for example, those dispersants disclosed in U.S. Pat. Nos. 5,804,667, 5,936,041, 5,026,495, 5,788,722, and 6,030,930, each of which is hereby incorporated by reference in its entirety.

The compositions of the present application further can include, for example, viscosity index improvers, anti-foamants, antiwear agents, demulsifiers, anti-oxidants, and other corrosion inhibitors.

Furthermore, the additives of the present application can be added with other compatible components that address other problems that may present themselves in an oil refining process known to one of ordinary skill in the art.

### EXAMPLES

The present application is further described by means of the examples, presented below. The use of such examples is illustrative only and in no way limits the scope and meaning of the invention or of any exemplified term. Likewise, the invention is not limited to any particular preferred embodiments described herein. Indeed, many modifications and variations of the invention will be apparent to those skilled in the art upon reading this specification. The invention is therefore to be limited only by the terms of the appended claims along with the full scope of equivalents to which the claims are entitled.

### Example 1

Several commercially available, metal-sulfonates, obtained from commercial sources, or were blended with organic borates (boronating agents) at elevated temperatures to form a series of products with high boron content in the following manner:

### Synthesis of Additive A

25 grams of a commercial calcium sulfonate [Chemtura C-4506 with 2.0 wt % calcium and a total base number of 8] were mixed with 25 grams of an organic boron additive [Mobilad C-700, 5.6 wt % boron] and the viscous mixture was heated to 80° C. for about 1.5 hours. The resulting final adduct upon cooling is a viscous, light brownish liquid.

### Synthesis of Additive B

25 grams of a commercial magnesium sulfonate [Lubrizol 6465 with 9.3 wt % magnesium and a total base number of 400] were mixed with 25 grams of an organic boron additive [Mobilad C-700, 5.6 wt % boron] and the viscous mixture was heated to 80° C. for about 1.5 hours. The resulting final adduct upon cooling is a dark brownish liquid.

### Synthesis of Additive C

25 grams of a commercial calcium sulfonate [Afton Hitec 611 with 11.9 wt % calcium and a total base number of 307] were mixed with 25 grams of an organic boron additive [Mobilad C-700, 5.6 wt % boron] and the viscous mixture was heated to 80° C. for about 1.5 hours. The resulting final adduct upon cooling is a dark brownish liquid.

### Synthesis of Additive D

25 grams of a commercial magnesium sulfonate [Infineum C-9340 with 9.1 wt % calcium and a total base number of 405] were mixed with 25 grams of an organic boron additive [Mobilad C-700, 5.6 wt % boron] and the viscous mixture was heated to 80° C. for about 1.5 hours. The resulting final adduct upon cooling is a brownish liquid.

### Synthesis of Additive E

20 grams of a commercial magnesium sulfonate [Infineum C-9340 with 9.1 wt % calcium and a total base number of 405], 20 grams of a commercial dispersant [Infineum C-9230 with 1.2 wt % nitrogen and 1.3 wt % boron] were mixed with 20 grams of an organic boron additive [Mobilad C-700, 5.6 wt % boron] and the viscous mixture was heated to 80° C. for about 1.5 hours. The resulting final adduct upon cooling is a viscous yellow-brownish liquid.

### Additive F

A commercial calcium sulfonate [Chemtura C-4506 with 2.0 wt % calcium and a total base number of 8] was obtained for use as an anti-fouling agent.

### Additive G

A commercial magnesium sulfonate [Lubrizol 6465 with 9.3 wt % magnesium and a total base number of 400] was used obtained for use as an anti-fouling agent.

### Additive H

A commercial calcium sulfonate [Afton Hitec 611 with 11.9 wt % calcium and a total base number of 307] was obtained for use as an anti-fouling agent.

### Additive I

A commercial magnesium sulfonate [Infineum C-9340 with 9.1 wt % calcium and a total base number of 405] was obtained for use as an anti-fouling agent.

### Example 2

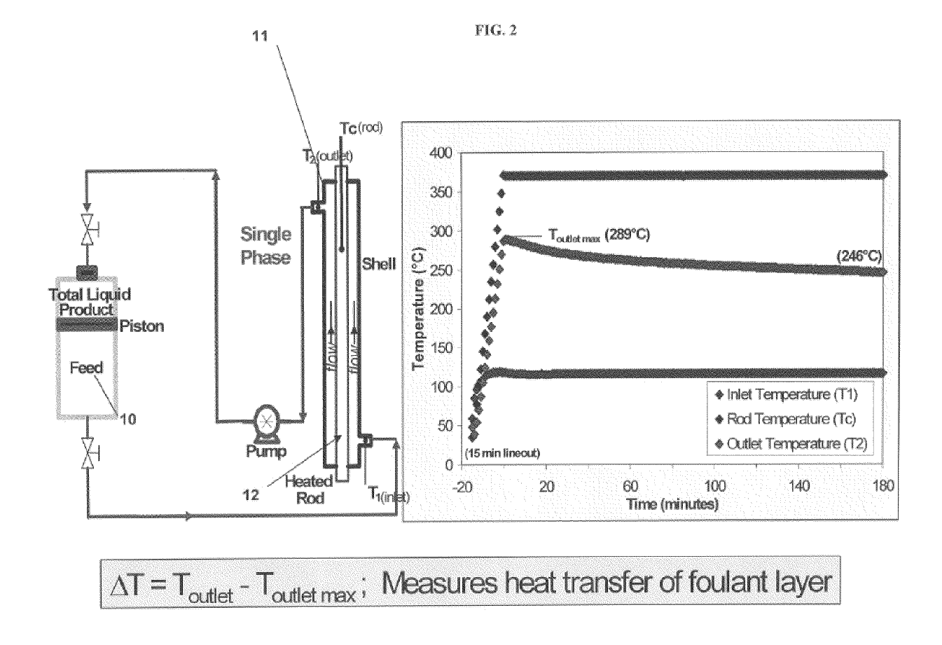

FIG. 2 depicts an Alcor HLPS (Hot Liquid Process Simulator) testing apparatus used to measure what the impact the addition of particulates to a crude oil has on fouling and what impact the addition of an additive of the present application has on the reduction and mitigation of fouling. The testing arrangement includes a reservoir 10 containing a feed supply of crude oil. The feed supply of crude oil may contain a base crude oil containing a whole crude or a blended crude containing two or more crude oils. The feed supply is heated to a temperature of approximately 150° C./302° F. and then fed into a shell 11 containing a vertically oriented heated rod 12. The heated rod 12 is formed from carbon-steel (1018). The heated rod 12 simulates a tube in a heat exchanger. The heated rod 12 is electrically heated to a surface temperature of 370° C./698° F. or 400° C./752° F. and maintained at such temperature during the trial. The feed supply is pumped across the heated rod 12 at a flow rate of approximately 3.0 mL/minute. The spent feed supply is collected in the top section of the reservoir 10. The spent feed supply is separated from the untreated feed supply oil by a sealed piston, thereby allowing for once-through operation. The system is pressurized with nitrogen (400-500 psig) to ensure gases remain dissolved in the oil during the test. Thermocouple readings are recorded for the bulk fluid inlet and outlet temperatures and for surface of the rod 12.

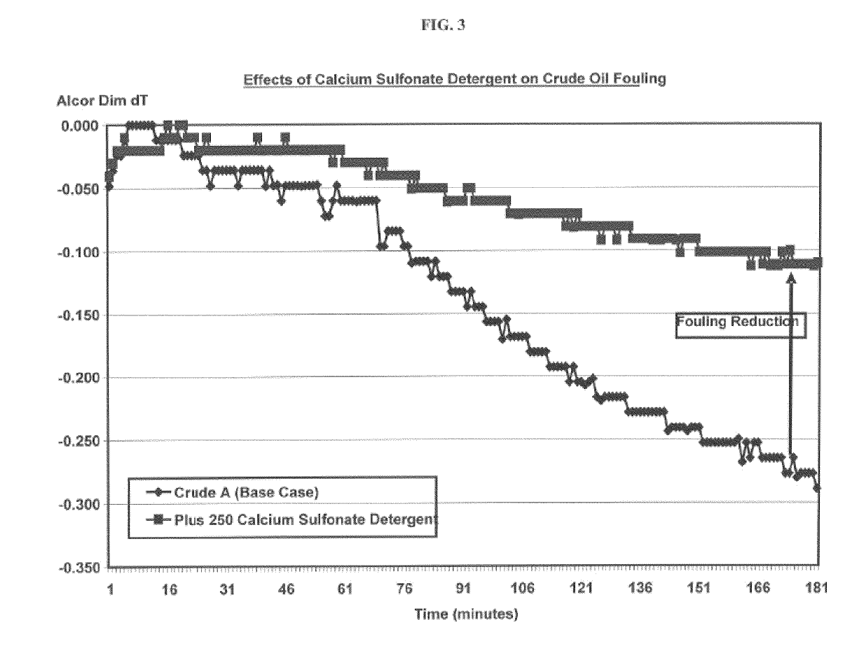

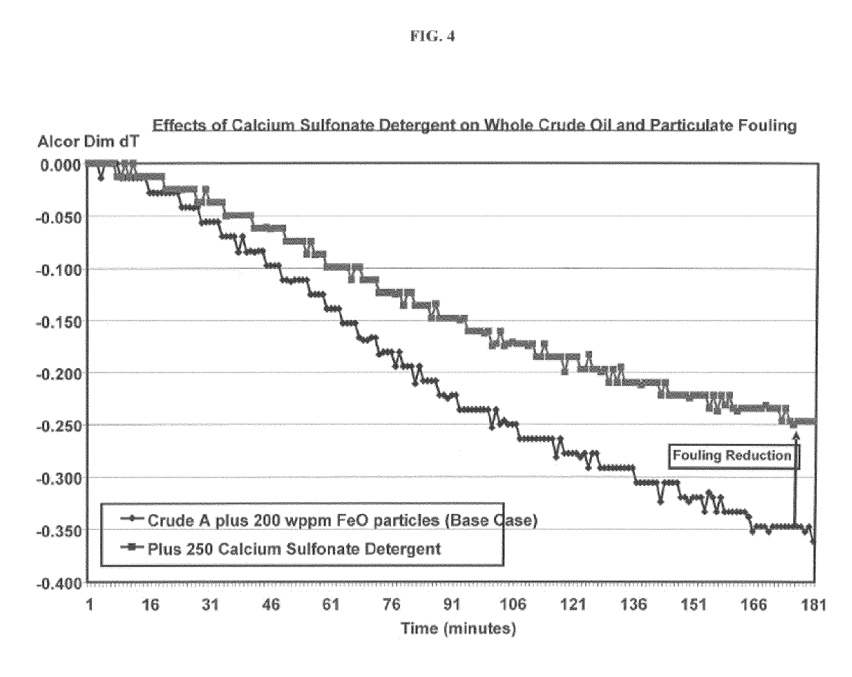

During the constant surface temperature testing, foulant deposits and builds up on the heated surface. The foulant deposits are thermally degraded to coke. The coke deposits cause an insulating effect that reduces the efficiency and/or ability of the surface to heat the oil passing over it. The resulting reduction in outlet bulk fluid temperature continues over time as fouling continues. This reduction in temperature is referred to as the outlet liquid ΔT or ΔT and can be dependent on the type of crude oil/blend, testing conditions and/or other effects, such as the presence of salts, sediment or other fouling promoting materials. A standard Alcor fouling test is carried out for 180 minutes. The total fouling, as measured by the total reduction in outlet liquid temperature over time, is plotted on the y-axis of FIG. 3 and FIG. 4 and is the observed outlet temperature (Tₒᵤₜₗₑₜ) minus the maximum observed outlet T_{outlet max} (presumably achieved in the absence of any fouling).

FIG. 3 illustrates the impact of fouling of a refinery component over 180 minutes. Two streams were tested in the Alcor unit: a crude oil control without an additive, and the same stream with 250 wppm of Infineum™ C9350, a long chain alkyl benzene sulfonate. As FIG. 3 demonstrates, the reduction in the outlet temperature over time (due to fouling) is less for the process stream containing 250 wppm of additive as compared to the crude oil control without the additive.

FIG. 4 demonstrates the results of the same test, except that 200 wppm (weight parts per million) of FeO particles were added to both streams. There was an increase in fouling in the presence of iron oxide particulate when compared to similar crude oils which that do not contain particulates (cf. FIGS. 3 and 4). As in FIG. 3, however, the stream that contains 250 wppm of Infineum™ C9350 exhibited less of an outlet temperature reduction, i.e. less fouling. FIG. 4 demonstrates that the long chain alkyl benzene sulfonate additive reduces fouling in streams that contain iron oxide particulates, as compared to the same stream without the additive.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims. It is further to be understood that all values are approximate, and are provided for description.

Patents, patent applications, publications, product descriptions, and protocols are cited throughout this application, the disclosures of each of which is incorporated herein by reference in its entirety for all purposes.

1. A method for reducing fouling in a hydrocarbon refining process comprising providing a crude hydrocarbon for a refining process;
adding an additive selected from: 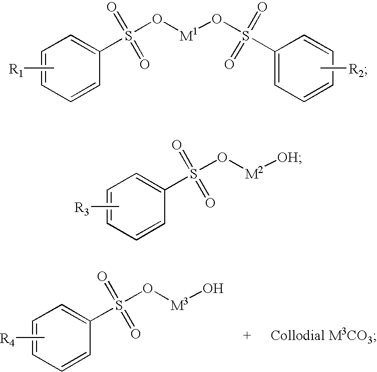
wherein R₁, R₂, R₃, and R₄ are independently selected from a branched or straight-chained C₅-C₈₀ alkyl group, and
M¹, M², and M³ are independently selected from Ca, Mg and Na.

2. The method of claim 1, wherein the additive is represented by the formula: 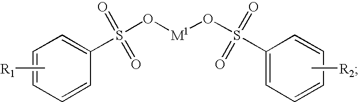
wherein R₁, and R₂ are independently selected from a branched or straight-chained C₅-C₈₀ alkyl group, and M₁ is selected from Ca, Mg and Na.

3. The method of claim 2, wherein M¹ is Ca.

4. The method of claim 2, wherein M¹ is Mg.

5. The method of claim 2, wherein M¹ is Na.

6. The method of claim 2, wherein R₁ and R₂ are independently selected from a straight-chained C₅-C₈₀ alkyl group

7. The method of claim 1, wherein the additive is represented by the formula: 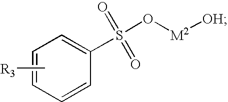
wherein R₃ is a branched or straight-chained C₅-C₈₀ alkyl group; and
M² is selected from Ca, Mg and Na.

8. The method of claim 7, wherein M² is Ca.

9. The method of claim 7, wherein M² is Mg.

10. The method of claim 7, wherein M² is Na.

11. The method of claim 7, wherein R₃ is a straight-chained C₅-C₈₀ alkyl group.

12. The method of claim 1, wherein the additive is represented by the formula: 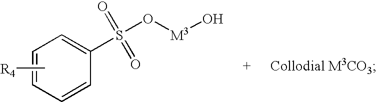
wherein R₄ is a branched or straight-chained C₅-C₈₀ alkyl group; and
M³ is selected from Ca, Mg and Na.

13. The method of claim 12, wherein M³ is Ca.

14. The method of claim 12, wherein M³ is Mg.

15. The method of claim 12, wherein M³ is Na.

16. The method of claim 12, wherein R₄ is a straight-chained C₅-C₈₀ alkyl group.

17. A system for refining hydrocarbons comprising;
at least one crude hydrocarbon refinery component; and
crude hydrocarbon in fluid communication with the at least one crude hydrocarbon refinery component, the crude hydrocarbon comprising an additive selected from: 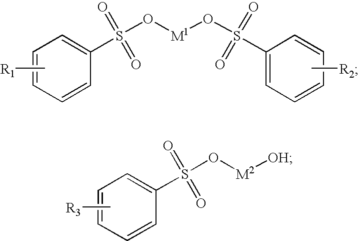
wherein R₁, R₂, R₃, and R₄ are independently selected from a branched or straight-chained C₅-C₈₀ alkyl group, and
M¹, M², and M³ are independently selected from Ca, Mg and Na.

18. The system of claim 17, wherein the at least one crude hydrocarbon refinery component is selected from a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, and a visbreaker.

19. The system of claim 18, wherein the at least one crude hydrocarbon refinery component is a heat exchanger.

20. A composition for reducing fouling, comprising:
(a) adding an additive selected from: 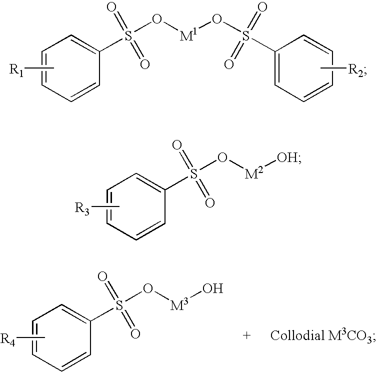
wherein R₁, R₂, R₃, and R₄ are independently selected from a branched or straight-chained C₅-C₈₀ alkyl group; M¹, M², and M³ are independently selected from Ca, Mg and Na.
(b) optionally, a solubilizer for the additive; and
(c) optionally, a dispersant for the additive.

21. A composition for reducing fouling, wherein a dispersant is present, and the dispersant comprises a boronating agent.

22. The composition of claim 21, wherein the boronating agent is selected from boric acid, trimethyl metaborate (trimethoxyboroxine), triethyl metaborate, tributyl metaborate, trimethyl borate, triethylborate, triisopropyl borate(triisopropoxyborane), tributyl borate(tributoxyborane) and tri-t-butyl borate.
